(19) United States
(12) Patent Application Publication
(10) Pub. No.: US 2009/0032493 A1
(43) Pub. Date: Feb. 5, 2009

(54) Method For Manufacturing Predetermined Pattern

(76) Inventor: Tsung Kuei Chang, Tao-Yuan (TW)

Correspondence Address: LIN & ASSOCIATES INTELLECTUAL PROPERTY, INC., P.O. BOX 2339, SARATOGA, CA, 95070-0339, US

(21) Appl. No.: 11/833,233

(22) Filed: Aug. 3, 2007

(51) Int. Cl. H01B 13/00

(52) U.S. Cl. 216/17

(57) ABSTRACT

A method for manufacturing a predetermined pattern is generally used to manufacture a predetermined pattern on PCBs. The method comprises a step of etching an insulating substrate of the PCB with a laser beam instead of chemical solutions to produce the predetermined pattern according to the layout of the predetermined patterns. The method may further comprise a step of applying metallization treatment on the predetermined pattern, thereby forming a desired trace. The laser etching has the advantages such as high precision and no chemical wastewater. The laser etching also overcomes the disadvantages of conventional manufacturing methods, such as uneven thickness and imprecision.

### BACKGROUND OF THE INVENTION

1. Field of the Invention

The present invention relates generally to a method for manufacturing a predetermined pattern, and in particular to a method for manufacturing a predetermined pattern formed by conductive adhesive.

2. The Prior Arts

A printed circuit board (PCB) is a non-conductive substrate on which interconnected circuits and components are laminated or etched. Chips and other electronic components are mounted on the circuits. According to a conventional method for manufacturing PCB's, copper foils are clad on insulating substrates, and etching (such as developing etching) is then used to produce predetermined patterns (such as circuits, registration holes, marks, etc.).

In more recent times, concerns have been raised regarding the advisability of using chemical etching, because chemical etching causes pollution problems. Chemical etching needs wastewater treatment system to treat the wastewater generated during the etching processes, and therefore the cost is increased.

Additionally, the chemical etching needs to strictly control the temperature, etching time, and ph value of the etching solution to produce the predetermined circuit with high precision. Because there are many factors to control for chemical etching, it is difficult to achieve the required precision. As the fine line circuit is gaining popularity, the chemical etching can not meet the requirement for fine line etching. At the same time, because the chemical etching is difficult to control in precision, deviations for multilayer PCBs, such as uneven thickness of layers, are likely to occur. The deviations accumulate as the number of layers increases. Therefore, the registration holes lose their function of precise registration, when there are many layers of substrates.

### SUMMARY OF THE INVENTION

A primary objective of the present invention is to provide a method for manufacturing a predetermined pattern, which employs laser to etch grooves for a predetermined circuit, thereby preventing pollution, imprecision, and uneven thickness caused by the chemical etching.

According to the above objective, a method for manufacturing a predetermined pattern in accordance with the present invention is disclosed to manufacture a predetermined pattern on a printed circuit board. The method in accordance with the present invention comprises a step of etching the insulating substrate of the provided PCB with a laser beam instead of chemical etching to form the predetermined pattern on the insulating substrate in accordance with the design of the predetermined pattern. If the predetermined pattern is for a circuit, the method further comprises a step of applying metallization treatment on the etched predetermined pattern, thereby forming the desired circuit trace.

### BRIEF DESCRIPTION OF THE DRAWINGS

The present invention will be apparent to those skilled in the art by reading the following detailed description of a preferred embodiments thereof, with reference to the attached drawings, in which:

FIG. 1A is a schematic view showing a method for manufacturing a predetermined pattern in accordance with the present invention which comprises a step of employing a laser beam to etch a groove on a substrate.

FIG. 1B is a schematic view showing the method for manufacturing the predetermined pattern in accordance with the present invention which further comprises a step of applying metallization treatment in the groove.

FIG. 1C is a schematic view showing the method for manufacturing the predetermined pattern in accordance with the present invention which further comprises a step of employing ultraviolet light to cure conductive adhesive in the groove.

### DETAILED DESCRIPTION OF THE PREFERRED EMBODIMENT

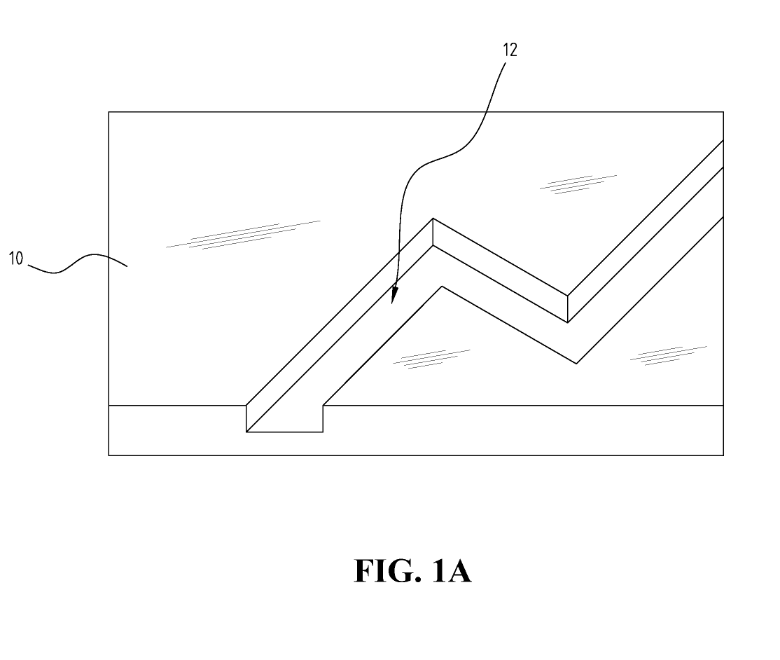

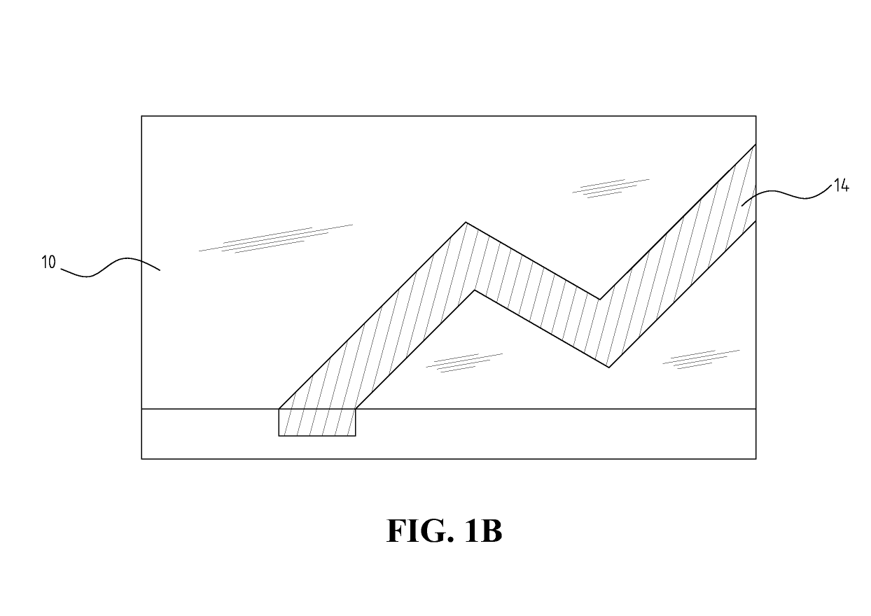

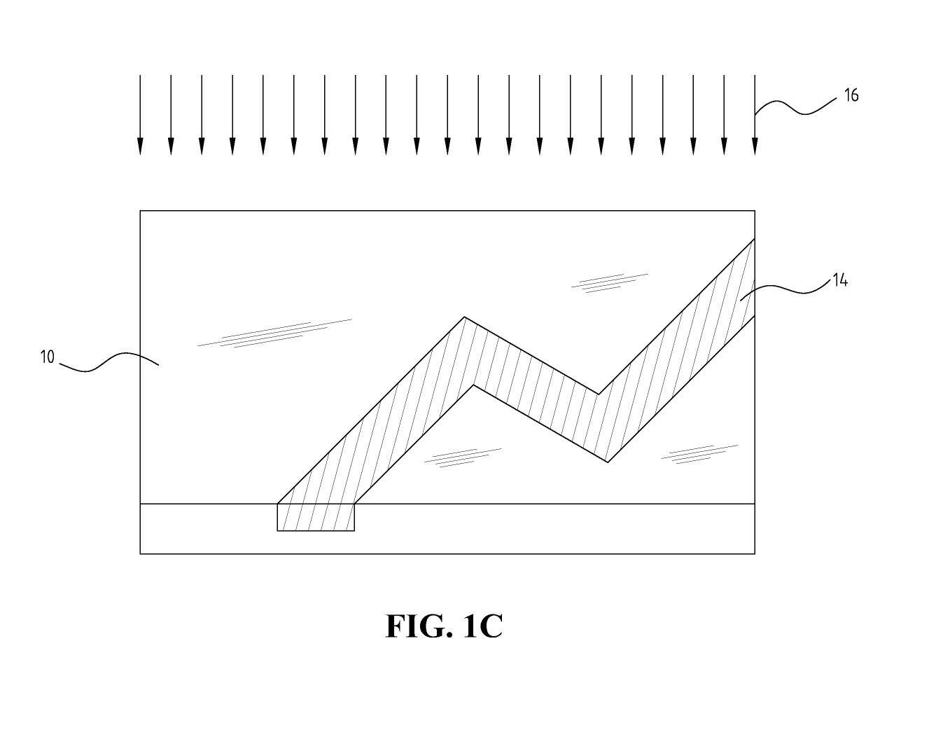

FIGS. 1A to 1C are schematic views showing the steps of a method for manufacturing a predetermined pattern in accordance with embodiments of the present invention. As shown in FIG. 1C, the method according to the present invention is primarily used to manufacture the predetermined pattern on an insulating substrate 10 of a PCB. In addition to the circuit trace as shown in FIG. 1C, the predetermined pattern may be registration holes and marks, such as serial number and the name of product manufacturer.

Briefly, the method for manufacturing the predetermined pattern in accordance with the present invention comprises the following steps: (1) providing an insulating substrate 10 of the PCB; and (2) using a laser beam instead of chemical solutions to etch the predetermined pattern, such as circuit trace grooves, serial number, name of product manufacturer, etc., on the insulating substrate 10 in accordance with the design of the predetermined pattern.

Referring to FIGS. 1A and 1B, a laser beam ablates the insulating substrate 10 to form a trace groove 12, which can be filled with conductive materials. Then, metallization treatment is used to produce the trace 14. The metallization is generally classified into two categories, one is conductive adhesive coating, and the other is electroless copper deposition, copper plating, or copper sputtering.

Referring to FIG. 1B, when the conductive adhesive is applied, the trace groove 12 according to a first embodiment is filled with the conductive adhesive 14. Ultraviolet light 16 then cures the conductive adhesive 14 as shown in FIG. 1C, thereby forming the trace 14 of the PCB.

Referring to FIG. 1B, the groove 12 according to a second embodiment may be filled with copper by electroless copper deposition, copper plating, or copper sputtering, thereby forming the trace 14.

After the trace 14 is completed, a same or similar method for manufacturing the printed circuit board can be used to finish the remaining job of manufacturing a multilayer PCB.

As described above, the method for manufacturing predetermined patterns in accordance with the present invention does not use high pollution chemical etching to create the trace groove 12. Therefore, it does not need wastewater treatment systems for chemical etching, and does not increase the manufacturing cost.

The method according to the present invention only needs to control the intensity of laser and the etching speed. It is easy to etch the trace groove 12 with precision. Thus, the method according to the present invention easily satisfies the requirements of the fine circuits. Also, the laser etching can be precisely controlled. Thus, deviations (such as uneven thickness of layer) are not likely to occur when the predetermined groove is etched and metallization is applied in the grooves. The total deviation will not become too large when the number of layers increases.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for manufacturing a predetermined pattern on a printed circuit board, comprising the following steps:
providing an insulating substrate of the printed circuit board; and
etching the insulating substrate with a laser beam to form a predetermined pattern in accordance with the design of the predetermined pattern.

2. The method as claimed in claim 1, wherein the predetermined pattern is one of a trace groove capable of being filled with a conductive material, a mark, and a registration hole.

3. The method as claimed in claim 2, wherein the method further comprises the steps of:
filling the trace groove with conductive adhesive; and
curing the conductive adhesive with ultraviolet light, thereby forming a trace of the PCB.

4. The method as claimed in claim 2, wherein the method further comprises the step of forming a trace in the trace groove by one of electroless copper deposition, copper plating, and vacuum sputtering.
